(19) United States
(12) Patent Application Publication
(10) Pub. No.: US 2013/0277338 A1
(43) Pub. Date: Oct. 24, 2013

(54) Resistance Welding Head with Parallel Electrodes

(71) Applicant: Shiton Yang, Guangzhou (CN)

(72) Inventor: Shiton Yang, Guangzhou (CN)

(21) Appl. No.: 13/997,668

(22) PCT Filed: Dec. 31, 2011
(86) PCT No.: PCT/CN2011/085099

§ 371 Date: Jun. 25, 2013

(30) Foreign Application Priority Data
Dec. 31, 2010 (CN) 201010619911.4

(51) Int. Cl. B23K 11/30

(52) U.S. Cl. CPC B23K 11/30
USPC 219/119

(57) ABSTRACT

A resistance welding head with parallel electrodes includes two parallel electrodes each having an electrode body and an insulation layer through which the two electrode bodies are insulatively secured to each other. An upper electrode tip and a lower electrode tip are disposed at two opposing ends of each electrode body respectively. The two upper electrode tips form an upper welding head tip of the resistance welding head with parallel electrodes, while the two lower electrode tips form a lower welding head tip of the resistance welding head with parallel electrodes. The upper welding head tip is able to weld the welding piece to be welded, and the lower welding head tip may also weld the welding piece.

### FIELD OF THE INVENTION

The present invention relates to resistance micro welding and more particularly, to a resistance welding head with parallel electrodes for resistance micro welding and paint stripping welding and having long lifetime.

### BACKGROUND OF THE INVENTION

In resistance welding technical field, two electrodes for performing spot welding are generally independent from each other and are not integral with each other. In case that the two electrodes are placed at top and bottom sides of a welding piece respectively, the two electrodes are referred to as upper and lower electrodes, while in case that two electrodes are disposed at the same side of the welding piece, they are referred to as parallel electrodes. In case two parallel electrodes are connected with each other, in present invention they are named as resistance welding head with parallel electrodes. It is noted that “resistance welding head with parallel electrodes” as used herein normally means a welding head in which two parallel electrodes are connected together unless otherwise specified.

Till now, many kinds of resistance welding heads with parallel electrodes have been taught by prior art technology. One example is normal resistance welding head with parallel electrodes in which welding head tips have no contact with each other and these tips are separated from each other. Another example is pre-stressed welding head as disclosed in Chinese Patent No. ZL93245377.5. A further example is spot welding head as disclosed in Chinese Patent No. ZL01114808X. Another example is resistance welding head with integral electrodes such as that disclosed in ZL200510121259.2. However, the above prior art resistance welding heads with parallel electrodes suffer commonly from short back of short lifetime and therefore, can't meet actual requirements for resistant micro welding and paint stripping welding.

Accordingly, there is a need for providing a resistance welding head with parallel electrodes having longer lifespan.

### SUMMARY OF THE INVENTION

By long term and repeated experiments and comprehensive analysis, the inventor has drawn a conclusion that short lifetime of prior art resistance welding head with parallel electrodes is caused by following reasons.

At first, a prior art resistance welding head with parallel electrodes only has one welding head tip for performing welding work, and another end is a welding head top portion which can't perform welding work.

Secondly, during welding process of a resistance welding head with parallel electrodes, the welding head tip must be ground and cleaned after welding of hundreds of welding spots and each time the tip is ground and cleaned, the height of the welding head tip is shortened, thus affecting lifetime of the resistance welding head with parallel electrodes.

Specifically, for both of pre-stressed welding head and spot welding head, the welding head tips of two parallel electrodes have to be pressed tightly against each other, while the rest portion of the welding head tips be bonded together by insulation adhesive. The welding head with above two constructions may be called as resistance welding head with parallel electrodes with a single tip contact surface. In a resistance welding head with parallel electrodes with a single tip contact surface, tips of the two electrodes are angled with respect to each other and are tightly pressed against each other. Tightly connected welding head tips have certain contact resistance. For example, under normal temperature, contact resistance of the two electrode tips of a normally used resistance welding head with parallel electrodes with a single tip contact surface is 8 mΩ. When output current is about 150 A, enameled cable with a diameter of Φ0.08 mm will have good welding effects. The welding principle is as follows. The welding head tips generate electric spark which then gets rids of insulating varnish to perform welding. As no additional force is applied to the tightly contacted welding head tips except for pre-stress imposed by metal, continuous operation of the welding head tips results in continuous generation electric spark. Metal thermal fatigue caused by high temperature necessarily changes contact resistance. At this time, the welding head tips should be ground and cleaned. However, the contact height of the angled tips of the resistance welding head with parallel electrodes with a single tip contact surface is very short for example is only 0.20 mm high measured with the help of high power microscope. Consequently, clearance of the welding head tips to be ground and cleaned is little and accordingly, the resistance welding head with parallel electrodes has short lifetime.

Resistance welding head with integral electrodes may be called as resistance welding head with parallel electrodes with integral tips. In a resistance welding head with parallel electrodes with integral tips, the welding head tips of the two parallel electrodes are integrated, while the rest portion is stuffed with insulating material and is combined as a whole. Structure of integral electrodes makes it necessary for the narrowest portion of the two electrodes, that is, the integral portion, has the largest resistance. Accordingly, high temperature will be resulted only when large current passes through the two electrodes and, insulating varnish is burned off to realize welding of the enameled cable. For example, an enameled cable having a diameter of Φ0.08 mm may be welded by a commonly used integral welding head. Under normal temperature, the resistance of the integral portion is 4 mΩ, and when the output current becomes 400 A, good welding effects will occur. Compared to welding head with a single tip contact surface, the integral tips of an integral welding head have stable resistance and therefore, it can bring reliable welding quality and longer lifetime. However, the integral tip portion of the resistance welding head with parallel electrodes is extremely tiny and as a result, when the welding head with integral tips continuously operates, tiny integral portion will be continuously subject to high temperature and large current, thus unavoidably expediting oxidization and property modification of metal portion of the integral tips. At this time, it is also necessary to grind and clean the welding head tip. As the metal portion of the two electrode tips of the resistance welding head with parallel electrodes with integral tips are continuous, the integral portion has relatively good conductivity. The integral portion must be machined to be very thin to generate high temperature at the tip portion. Specific experiments are done to measure magnitude of current required by the integral tip with different size. That is, the integral portions are made of tungsten and are machined to be 0.8 mm long and 0.15 mm wide. They are used to weld an enameled cable with a diameter of 0.08 mm. During above welding process, current is measured when the integral portions with different height are used. It has been found that current of 400 A is required when the height of the integral portion is 0.30 mm; current of 600 A is needed when the height of the integral portion is 0.40 mm; and current of 1200 A is required when the height of the integral portion is 0.50 mm. Obviously, current will be significantly increased when the height of the integral portion is increased. As the output energy value relates to square of current value, increase of integral portion height results in quick increase of output energy which is unacceptable for a welding machine or welding piece which can only be welded by micro welding. In other words, grinding and cleaning clearance of the welding head tips of the resistance welding head with parallel electrodes with integral tips is not much enough.

Based on above analysis, the object of the present invention is to provide a resistance welding head with parallel electrodes with long lifetime for resistance micro welding and paint stripping welding.

To realize above object, the present invention offers a resistance welding head with parallel electrodes including two parallel electrodes each having an electrode body and an insulation layer through which the two electrode bodies are insulatively secured to each other. An upper electrode tip and a lower electrode tip are disposed at two opposing ends of each electrode body respectively. The two upper electrode tips form an upper welding head tip of the resistance welding head with parallel electrodes, while the two lower electrode tips form a lower welding head tip of the resistance welding head with parallel electrodes. The upper welding head tip is able to weld the welding piece to be welded, and the lower welding head tip may also weld the welding piece.

As an improvement of the resistance welding head with parallel electrodes of the invention, the two parallel electrodes are separated from each other and are independently arranged. The two upper electrode tips are pressed tightly against each other, and the two lower electrode tips are also pressed tightly against each other.

As an improvement of the resistance welding head with parallel electrodes of the invention, a metal sheet is disposed between the two upper electrode tips and/or between the two lower electrode tips.

As an improvement of the resistance welding head with parallel electrodes of the invention, the metal sheet electrically conductively contacts the two upper electrode tips disposed at two lateral sides of the sheet and/or electrically conductively contacts the two lower electrode tips disposed at two lateral sides of the sheet.

As an improvement of the resistance welding head with parallel electrodes of the invention, under normal temperature, contact resistance between the metal sheet and upper electrode tips and/or between the metal sheet and lower electrode tips is about 10 mΩ.

As an improvement of the resistance welding head with parallel electrodes of the invention, the thickness of the metal sheet is about 0.03-0.10 mm.

As an improvement of the resistance welding head with parallel electrodes of the invention, the height of the metal sheet disposed between the upper electrode tips and/or between the lower electrode tips is about 3-5 mm.

As an improvement of the resistance welding head with parallel electrodes of the invention, one end of the metal sheet away from the upper electrode tips and/or lower electrode tips is secured onto the insulation layer.

As an improvement of the resistance welding head with parallel electrodes of the invention, the metal sheet is made of high conductive, high temperature resistant and sufficiently hard material.

As an improvement of the resistance welding head with parallel electrodes of the invention, the metal sheet is constructed of tungsten, molybdenum, tungsten alloy or molybdenum alloy.

As an improvement of the resistance welding head with parallel electrodes of the invention, one of the two parallel electrodes is broken in its central region and this broken central region is filled with insulation material.

As an improvement of the resistance welding head with parallel electrodes of the invention, the two upper electrode tips of the two parallel electrodes are integrally formed, and the two lower electrode tips thereof are also integrally formed. In addition, one of the two parallel electrodes is broken in its central region and two segments divided by the central region are insulated from each other.

As an improvement of the resistance welding head with parallel electrodes of the invention, the two upper electrode tips of the two parallel electrodes are separated from each other, and the two lower electrode tips of the two parallel electrodes are separated from each other. The two upper electrode tips are insulated from each other by an insulation layer. The two lower electrode tips are also insulated from each other by an insulation layer.

As an improvement of the resistance welding head with parallel electrodes of the invention, the insulation layer is insulation adhesive layer.

Compared to prior art technology, the resistance welding head with parallel electrodes of the invention at least has the following advantages.

At first, the resistance welding head with parallel electrodes is mostly used to weld enameled cable with diameter of 0.10 mm or less. During fabrication of kinds of resistance welding head with parallel electrodes, it should have extremely high fabrication accuracy. Equipments intended for making of the resistance welding head with parallel electrodes are expensive and fabrication process involves tens of precise steps. As a result, manufacture cost of resistance welding head with parallel electrodes is very high. In present invention, a prior art resistance welding head with parallel electrodes having only one welding head tip is machined to be a resistance welding head with parallel electrodes having two welding head tips using basically the same process and equipments. Though material cost is slightly increased, the lifetime of the resistance welding head with parallel electrodes is significantly extended.

Secondly, the tip height of a prior art resistance welding head with parallel electrodes with a single tip contact surface is only about 0.20 mm and accordingly, grinding and cleaning clearance of the welding head tip is insufficient. Comparatively in the resistance welding head with parallel electrodes of the present invention, a metal sheet is presented at the welding head tip thus forming double tip contact surfaces. The height of the metal sheet disposed on the welding head tip is 3-5 mm and accordingly, the grinding and cleaning clearance of the welding head tip of the resistance welding head with parallel electrodes is enough, thereby effectively extending lifetime of the resistance welding head with parallel electrodes.

### BRIEF DESCRIPTION OF THE DRAWINGS

The resistance welding head with parallel electrodes of the invention and its good effects will be described in greater detail in conjunction with accompanying drawings and various embodiments.

FIG. 1 shows a schematic view of a resistance welding head with parallel electrodes according to a first embodiment of the invention;

FIG. 2 shows a schematic view of a resistance welding head with parallel electrodes according to a second embodiment of the invention;

FIG. 3 shows a partially enlarged view of the resistance welding head with parallel electrodes of FIG. 2;

FIG. 4 shows a schematic view of a resistance welding head with parallel electrodes according to a third embodiment of the invention; and

FIG. 5 shows a schematic view of a resistance welding head with parallel electrodes according to a fourth embodiment of the invention.

### DETAILED DESCRIPTION OF THE INVENTION

Referring to FIG. 1, according to a first embodiment of the invention, a resistance welding head with parallel electrodes 10 includes two parallel electrodes and an insulation layer 100 sandwiched between the two parallel electrodes. The two parallel electrodes are separated from each other and are independently arranged. Each parallel electrode includes a main body 102a, an upper electrode tip 102b located at an upper end of the main body 102a and a lower electrode tip 102c located at a lower end of the main body 102a. The two parallel electrodes are insulatively connected with each other by the insulation layer 100. Two upper electrode tips 102b of the two parallel electrodes tightly contact each other to perform welding to a welding piece to be welded. Two lower electrode tips 102c also tightly contact each other to perform welding to a welding piece to be welded.

Reference is further made to FIG. 1. In this embodiment shown in FIG. 1, a main body 102a of one parallel electrode (the parallel electrode located at right side of FIG. 1) of the resistance welding head with parallel electrodes 10 is broken in its central region and this central region is filled with insulation material 108.

There is no limit to manner by which the two parallel electrodes are secured insulatively to each other as long as the two parallel electrodes can be stably fixed to each other, two upper electrode tips 102b can tightly contact each other, and two lower electrode tips 102c can also tightly contact each other to perform micro welding to the welding piece. For example, according to a preferred embodiment of the invention, the two parallel electrodes may be connected with each other by an insulation adhesive layer such as curing adhesive layer marketed as Loctite chipbondec.

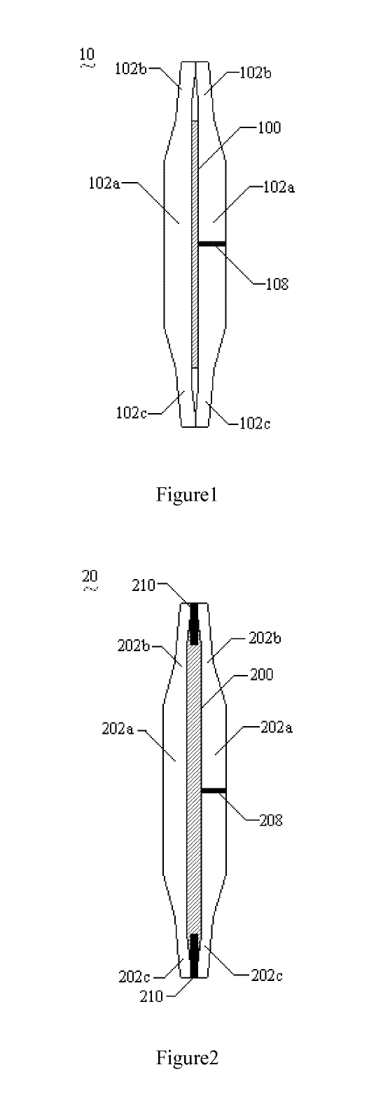

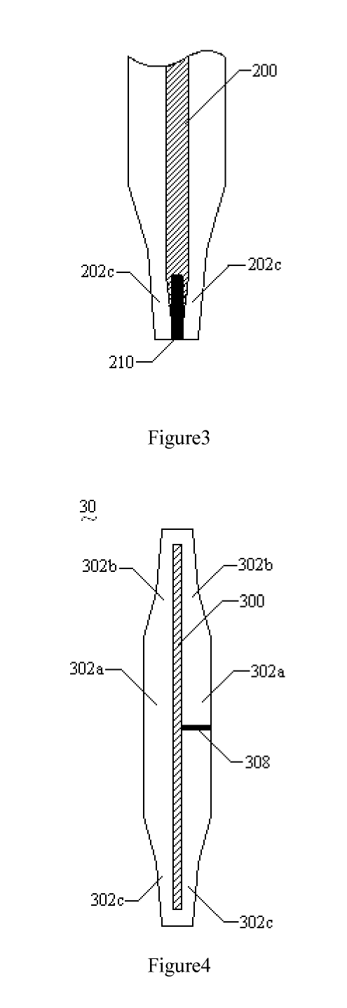

Please refer to FIGS. 2-3, according to a second embodiment of the invention, a resistance welding head with parallel electrodes 20 includes two parallel electrodes and an insulation layer 200 sandwiched between the two parallel electrodes. The two parallel electrodes are separated from each other and are independently arranged. Each parallel electrode includes a main body 202a, an upper electrode tip 202b located at an upper end of the main body 202a and a lower electrode tip 202c located at a lower end of the main body 202a. The two parallel electrodes are insulatively connected with each other by the insulation layer 200. Two upper electrode tips 202b of the two parallel electrodes tightly contact each other. Two lower electrode tips 202c also tightly contact each other. A main body 202a of one parallel electrode (the parallel electrode located at right side of FIG. 2) of the resistance welding head with parallel electrodes 20 is broken in its central region and this central region is filled with insulation material 208.

Different from the first embodiment, in second embodiment of the resistance welding head with parallel electrodes 20 of the invention shown in FIGS. 2-3, a joint interface between the two upper electrode tips 202b is provided with a metal sheet 210 and, a joint interface between the two lower electrode tips 202c is also provided with a metal sheet 210. Arrangement of the metal sheets 210 results in double contact surfaces between the two upper electrode tips 202b and between the two lower electrode tips 202c so as to weld the welding piece respectively.

One end of the metal sheet 210 is disposed between the two upper electrode tips 202b or between the two lower electrode tips 202c of the two parallel electrodes and tightly contact the two upper electrode tips 202b or two lower electrode tips 202c and has good conductivity. The other end of the metal sheet 210 is connected to the two parallel electrodes through high temperature resistant adhesive such as curing adhesive layer marketed as Loctite chipbondec. According to a preferred embodiment of the invention, under normal temperature, contact resistance between the metal sheet 210 and upper electrode tips 202b and/or between the metal sheet 210 and lower electrode tips 202c is about 10 mΩ.

The thickness of the metal sheet 210 is corresponding to width of a gap defined between the two parallel electrodes to ensure tight contact with the two parallel electrodes. According to a preferred embodiment of the resistance welding head with parallel electrodes 20 of the invention, the thickness of the metal sheet 201 is approximately 0.03-0.10 mm. The height of the metal sheet 210 disposed between the upper electrode tips 202b and/or between the lower electrode tips 202c is about 3-5 mm.

The metal sheet 210 is made of high conductive, high temperature resistant and sufficiently hard material. For example, according to a preferred embodiment of the invention, the metal sheet 210 is constructed of tungsten, molybdenum, tungsten alloy or molybdenum alloy.

Arrangement of the metal sheets 210 results in double contact surfaces between the two upper electrode tips 202b and between the two lower electrode tips 202c respectively so as to weld the welding piece respectively. During running of the resistance welding head with parallel electrodes 20, when large current flows across the upper electrode tips 202b and lower electrode tips 202c both of which have double contact surfaces, two surfaces by which the metal sheet 210 contacts the two parallel electrodes will produce electric spark which in turn will remove insulation paint covered on an enameled cable. The large current flows into the welding piece, thus realizing resistance welding process with the help of welding force.

At one hand, as the metal sheets 201 are disposed between the upper electrode tips 202b and between the lower electrode tips 202c of the two parallel electrodes respectively, there is no need for pre-stressing the upper electrode tips 202b and lower electrode tips 202c of the two parallel electrodes and therefore, metal thermal fatigue has little influence on lifespan of the resistance welding head with parallel electrodes 20. High temperature and large current is cable of not only removing partial insulation adhesive on two surfaces of the metal sheet 201, but also ensuring there is minimum contact resistance for the welding head at locations adjacent the upper electrode tips 202b and lower electrode tips 202c. As such, influence of metal oxidization or metal property modification on lifespan of the resistance welding head with parallel electrodes 20 can be eliminated by grinding the upper electrode tips 202b and lower electrode tips 202c. Specifically, the metal oxidization layer or metal property modification layer may be removed such that the resistance welding head with parallel electrodes 20 can work normally again. The metal sheet 210 thus arranged has certain length and therefore, the resistance welding head with parallel electrodes 20 may be repeatedly ground and cleaned, hence greatly extending lifetime of the resistance welding head with parallel electrodes 20.

At the other hand, as the resistance welding head with parallel electrodes 20 having double contact surfaces has metal contact surfaces, electric spark will be generated by small current, thus getting rid of insulation paint on the enameled cable.

It is clear from above description that the tip height of a prior art resistance welding head with parallel electrodes with a single tip contact surface is only about 0.20 mm, and grinding and cleaning clearance of the electrode tips is very small. Comparatively, according to the second embodiment of the resistance welding head with parallel electrodes 20 of the invention, metal sheets 210 are pre-located between the electrode tips 202b and between the electrode tips 202c of the resistance welding head with parallel electrodes having double tip contact surfaces, and the height of the metal sheets 210 disposed between the upper electrode tips and/or between the lower electrode tips is about 3-5 mm. Consequently, there is sufficient grinding and cleaning clearance for the resistance welding head with parallel electrodes 20, hence the lifetime of the resistance welding head with parallel electrodes 20 being extended effectively.

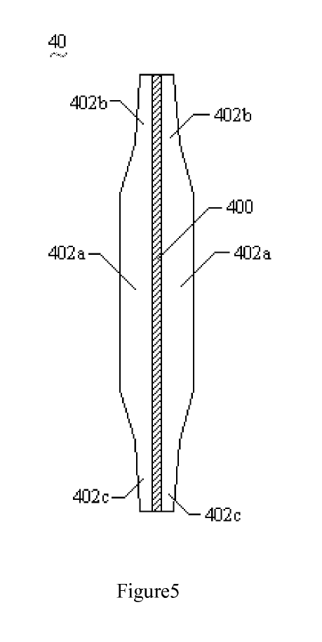

Please refer to FIG. 4. According to a third embodiment of the invention, a resistance welding head with parallel electrodes 30 includes two parallel electrodes and an insulation layer 300 sandwiched between the two parallel electrodes. Each parallel electrode includes a main body 302a, an upper electrode tip 302b located at an upper end of the main body 302a and a lower electrode tip 302c located at a lower end of the main body 302a. The two main bodies 302a are insulatively connected with each other by the insulation layer 300.

Different from the first embodiment, in third embodiment of the resistance welding head with parallel electrodes 30 of the invention, the two upper electrode tips 302b and two lower electrode tips 302c of the two parallel electrodes are not independently arranged. Rather, they are formed integrally to weld the welding piece respectively. The entire welding head with parallel electrodes 30 is integrally arranged.

Reference is further made to FIG. 4. In this illustrated embodiment, the main body 302a of a parallel electrode (the electrode at right side of FIG. 4) of the welding head with parallel electrodes 30 is broken in its central region and this region is filled with insulation material 308 and two segments divided by the central region are insulated from each other.

Reference is made to FIG. 5. According to a fourth embodiment of the invention, a resistance welding head with parallel electrodes 40 includes two parallel electrodes and an insulation layer 400 sandwiched between the two parallel electrodes. The two parallel electrodes are separated from each other and are independently arranged. Each parallel electrode includes a main body 402a, an upper electrode tip 402b located at an upper end of the main body 402a and a lower electrode tip 402c located at a lower end of the main body 402a. The two main bodies 402a are insulatively connected with each other by the insulation layer 400.

Different from the first embodiment, in fourth embodiment of the resistance welding head with parallel electrodes 40 of the invention, though both of the two upper electrode tips 402b and two lower electrode tips 402c of the two parallel electrodes can weld the welding piece respectively, the two upper electrode tips 402b are separated from each other, and the two lower electrode tips 402c are also separated from each other. The two upper electrode tips 402b are isolated from each other by the insulation layer 400. The two lower electrode tips 402c are also isolated from each other by the insulation layer 400. At this time, the central region of the main body 402a of the two parallel electrodes is not broken and of course there is no need for filling it with insulation material.

From above four embodiments, it can be found that each parallel electrode of each embodiment in fact has this kind of construction: an electrode main body (i.e., the main body aforementioned) and an upper electrode tip and lower electrode tip formed from the two opposing ends of the electrode main body. The two upper electrode tips form an upper welding head tip of the resistance welding head with parallel electrodes, while the two lower electrode tips form a lower welding head tip of the resistance welding head with parallel electrodes.

The preparation process of the resistance welding head with parallel electrodes of the invention will be discussed below with reference to drawings. It is noted however, as preparation process of the resistance welding head with parallel electrodes in each embodiment is basically identical, the resistance welding head with parallel electrodes 20 of the second embodiment will be taken as an example to explain the preparation process of the resistance welding head with parallel electrodes, and processes for other embodiments will not be provided hereinafter.

Reference is made to FIGS. 2-3. Firstly, conductive, high temperature resistant and sufficiently hard electrode material is machines to be a cylinder. Next, the cylinder is further processed to form two symmetrical semi-cylindrical parallel electrodes, and the upper end of each semi-cylindrical parallel electrode is machined to form an upper electrode tip 202b, and the lower end thereof is machined to be a lower electrode tip 202c. After that, the two semi-cylindrical parallel electrodes are engaged with each other and two metal sheets 210 are disposed between the two upper electrode tips 202b and between the two lower electrode tips 202c respectively. Then, insulation adhesive is injected into a region between the two parallel electrodes such that the two parallel electrodes and metal sheets 210 are fixed with each other by an insulation layer 200. Finally, the resistance welding head with parallel electrodes 200 is machined, and the metal sheets 210 are handled to have a shape conformal to that of the upper electrode tips 202b and lower electrode tips 202c. At this time, the two upper electrode tips 202b of the two parallel electrodes are pressed tightly against one metal sheet 210 correspondingly and, two lower electrode tips 202c are also pressed tightly against the other metal sheet 210 correspondingly.

It can be seen from above description regarding various embodiments of the resistance welding head with parallel electrodes of the invention that, the resistance welding head with parallel electrodes of the invention has the following advantages compared to prior art technology.

The resistance welding head with parallel electrodes is mostly used to weld enameled cable with diameter of 0.10 mm or less. During fabrication of kinds of resistance welding head with parallel electrodes, it should have extremely high manufacture accuracy. Equipments intended for making of the resistance welding head with parallel electrodes are expensive and fabrication process involves tens of precise steps. As a result, manufacture cost of resistance welding head with parallel electrodes is very high. In present invention, a prior art resistance welding head with parallel electrodes having only one welding head tip is machined to be a resistance welding head with parallel electrodes having two welding head tips using basically the same process and equipments. Though material cost is slightly increased, the lifetime of the resistance welding head with parallel electrodes is significantly extended.

Though various embodiments of the invention have been illustrated above, a person of ordinary skill in the art will understand that, variations and improvements made upon the illustrative embodiments fall within the scope of the invention, and the scope of the invention is only limited by the accompanying claims and their equivalents.

1. A resistance welding head with parallel electrodes comprising two parallel electrodes each having an electrode body and an insulation layer through which the two electrode bodies are insulatively secured to each other, wherein an upper electrode tip and a lower electrode tip are disposed at two opposing ends of each electrode body respectively;
the two upper electrode tips form an upper welding head tip of the resistance welding head with parallel electrodes, while the two lower electrode tips form a lower welding head tip of the resistance welding head with parallel electrodes; the upper welding head tip is able to weld the welding piece to be welded, and the lower welding head tip is also able to weld the welding piece.

2. The resistance welding head with parallel electrodes according to claim 1, wherein the two upper electrode tips are pressed tightly against each other and the two lower electrode tips are also pressed tightly against each other.

3. The resistance welding head with parallel electrodes according to claim 3, wherein a metal sheet is disposed between the two upper electrode tips and/or between the two lower electrode tips.

4. The resistance welding head with parallel electrodes according to claim 3, wherein the metal sheet electrically conductively contacts the two upper electrode tips disposed at two lateral sides of the sheet and/or electrically conductively contacts the two lower electrode tips disposed at two lateral sides of the sheet.

5. The resistance welding head with parallel electrodes according to claim 3, wherein under normal temperature, contact resistance between the metal sheet and upper electrode tips and/or between the metal sheet and lower electrode tips is 10 mΩ.

6. The resistance welding head with parallel electrodes according to claim 3, wherein the thickness of the metal sheet is 0.03-0.10 mm.

7. The resistance welding head with parallel electrodes according to claim 3, wherein the height of the metal sheet disposed between the upper electrode tips and/or between the lower electrode tips is 3-5 mm.

8. The resistance welding head with parallel electrodes according to claim 3, wherein one end of the metal sheet away from the upper electrode tips and/or lower electrode tips is secured onto the insulation layer.

9. The resistance welding head with parallel electrodes according to claim 3, wherein the metal sheet is made of high conductive, high temperature resistant and sufficiently hard material.

10. The resistance welding head with parallel electrodes according to claim 3, wherein the metal sheet is constructed of tungsten, molybdenum, tungsten alloy or molybdenum alloy.

11. The resistance welding head with parallel electrodes according to claims 1, wherein one of the two parallel electrodes is broken in its central region and this broken central region is filled with insulation material.

12. The resistance welding head with parallel electrodes according to claim 1, wherein the two upper electrode tips of the two parallel electrodes are integrally formed, and the two lower electrode tips thereof are also integrally formed; in addition, one of the two parallel electrodes is broken in its central region and two segments divided by the central region are insulated from each other.

13. The resistance welding head with parallel electrodes according to claim 1, wherein the two upper electrode tips of the two parallel electrodes are separated from each other and the two lower electrode tips of the two parallel electrodes are separated from each other;
the two upper electrode tips are insulated from each other by the insulation layer; and the two lower electrode tips are also insulated from each other by the insulation layer.

14. The resistance welding head with parallel electrodes according to claim 1, wherein the insulation layer is an insulation adhesive layer.
